(19) United States
(12) Patent Application Publication
(10) Pub. No.: US 2016/0110472 A1
(43) Pub. Date: Apr. 21, 2016

(54) IDENTIFYING, MARKING UP, AND RECONSTITUTING ELEMENTS FOR CONTENT SHARING

(71) Applicant: LiveRelay INC., San Diego, CA (US)

(72) Inventors: Kayeung Cheung, San Diego, CA (US); Steven Lee Shen, San Marcos, CA (US)

(21) Appl. No.: 14/515,254

(22) Filed: Oct. 15, 2014

(51) Int. Cl. G06F 17/30; H04L 29/08

(52) U.S. Cl. CPC G06F 17/30905; G06F 17/30896; H04L 67/02

(57) ABSTRACT

A method of identifying, marking-up and reconstituting web content elements for content sharing has steps including receiving, by an originator device, a webpage, the webpage having content objects and an originator layout when displayed on the originator device. Also, identifying, a target object selected by a user from the content objects, where an identity of the target object is stored on a locator list. Also, applying a mark-up to the target object. Also, instructing, the server to transmit the mark-up and the locator list to one or more recipient devices. Also, identifying the target object on the recipient device that corresponds to the target object on the originator device. Also, applying a mark-up to the target object on the recipient device, the mark-up defining a reconstitution of the webpage on the recipient device. Also, displaying, by the recipient device, the mark-up on the webpage as viewed on the recipient device.

### TECHNICAL FIELD

The subject matter described herein relates to sharing marked up content.

### BACKGROUND

Modern websites are built responsively; that is a technique called Response Web Design is employed to provide an optimal viewing experience. This may include dynamic resizing, panning, scrolling, etc. Also, additional content is continually added to webpages, particularly on webpages for news organization or blogs. The result is that the same page that an originator (or first user) views may not be the same as what is provided to a recipient (or second user) at some later point in time. When content is shared between two or more users, it may be important to provide a common point of reference for the shared content.

### SUMMARY

In one aspect, a method of identifying, marking-up and reconstituting web content elements for content sharing has steps including receiving, by an originator device, having a computer memory, from a web server via a network, a webpage, the webpage having web content that includes one or more content objects and an originator layout when displayed on a display associated with the originator device. Also, generating, by a program code module executed on the originator device, a context of the webpage that corresponds to the originator layout. Also, identifying, by the program code module, at least one of the one or more content objects of the webpage as being a target object selected by a user from the one or more content objects, wherein an identity of the target object is stored on a locator list. Also, applying, by the program code module and based on the identifying, a mark-up to the target object. Also, instructing, by the program code module, the server to transmit the mark-up and the locator list to one or more recipient devices. Also, identifying, by the program code module accessing the locator list, from at least one of the one or more content objects of the webpage present on the recipient device, the target object on the recipient device that corresponds to the target object on the originator device. Also, applying, by the program code module and based on the identifying, a mark-up to the target object on the recipient device, the mark-up defining a reconstitution of the webpage on the recipient device. Also, displaying, by the recipient device, the mark-up on the webpage as viewed on the recipient device.

In some variations one or more of the following features can optionally be included in any feasible combination.

Implementations of the current subject matter can provide one or more advantages. For example, in one implementation, the recipient device is selected, by the program code module, from a recipient list stored in the computer memory of the originator device.

In another implementation, the program code module creates a locator list storing attributes associated with the identity of the target object on the originator device, and wherein the locator list is stored in the computer memory of the originator device.

In another implementation, the program code module creates a unique object having stored, in machine-readable instructions, attributes associated with the identity of the target object on the originator device, for identifying the target object on the originator device.

In another implementation, the program code module creates a limiter object having stored, in machine-readable instructions, attributes associated with the identity of the target object on the originator device, for identifying the target object on the originator device.

In another implementation, the unique object and the limiter object are stored in the locator list.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to identifying, marking up, and reconstituting elements for content sharing, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a webpage having an originator layout on an originator device;

FIG. 2 illustrates the webpage with objects identified in the originator layout;

FIG. 3 illustrates mark-ups applied to target objects in the originator layout;

FIG. 4 illustrates a recipient layout of a recipient device displaying the mark-ups associated with the target objects from the webpage;

FIG. 5 is a process flow diagram illustrating the steps in generating the mark-ups on the target object displayed on the originator device and replicating the mark-ups on the recipient device;

FIG. 6 is process flow diagram illustrating an Anchor Identification Strategy (AIS) determining unique identifiers for the target object; and

FIG. 7 is a diagram illustrating aspects of a system showing features consistent with implementations of the current subject matter.

When practical, similar reference numbers denote similar structures, features, or elements.

### DETAILED DESCRIPTION

The subject matter of this application describes a method and/or system for identifying, marking up, and reconstituting elements for content sharing. References in this specification to “an implementation,” “one implementation,” and the like, mean that the particular feature, structure, or characteristic being described is included in at least one implementation of the present invention. Occurrences of such phrases in this specification do not necessarily all refer to the same implementation.

In one implementation, a user can display a webpage on an originator device to mark up a portion of, or object within, of the webpage of interest to the user. The user can then transmit information about the marked up webpage to a recipient using a recipient device. It is increasingly common that the recipient may not have the same type, size, or platform of viewing device as the user. In this case, information about the marked up object is used to determine the analogous object on the recipient device. This allows the recipient to view the mark-up in the way that the user intended. Modern web content presents a particular challenge for replicating analogous mark-ups between differing devices. Web content typically has multiple identifying features that allow a common point of reference between the user and the recipient. An Anchor Identification Strategy (AIS) can be employed that uses the identifying features to apply the mark-up accurately between the user and the recipient.

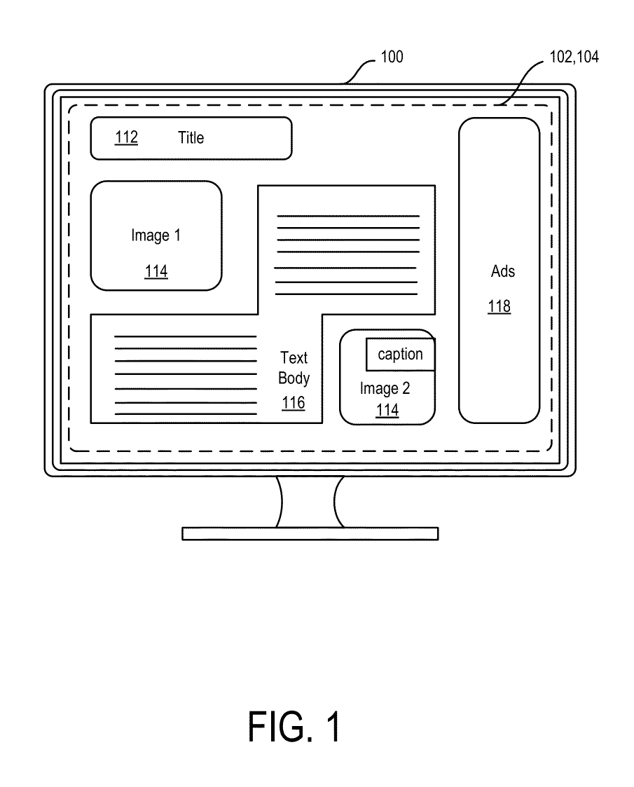

FIG. 1 illustrates an originator device 100, having a webpage 102 with an originator layout 104. In one implementation, the originator device 100 is a personal computer (PC), with FIG. 1 illustrating the webpage 102 shown on the monitor of the PC. The originator device 100 may be any sort of electronic or computational device that displays information, e.g. a smartphone, a kiosk, a tablet, a data terminal, a touch display, or a scanner.

The webpage 102 is shown as an example of content that may be displayed on the originator device 100. Relating to the current subject matter, the “webpage” may refer to any sort of items, objects, entities, instances, or data capable of being displayed or otherwise presented by the originator device 100. Other examples of the “webpage” may include, e.g. desktop displays (i.e. windows), individual images, or graphical-user interfaces. In other implementations, the content may include time-varying data streams, e.g. an audio or video playback or feed.

The originator layout 104 is the arrangement of displayed information on the originator device 100. In one implementation, the originator layout 104 is the arrangement and kinds of objects on the webpage 102. The originator layout 104 may be any group of objects, information, or data, e.g. titles 112, images 114, text bodies 116, or advertisements 118. The originator layout 104 may be changed periodically due to updates in the content, resizing of windows, or other changes initiated by the user or the provider of the webpage 102 content. The originator layout 104 may be defined in many ways, e.g. as a collection of coordinates, mappings, distances, levels, layers, or depths. In time-varying content such as a video or audio playback, the originator layout 104 may also refer to time-sequences within the specific playbacks.

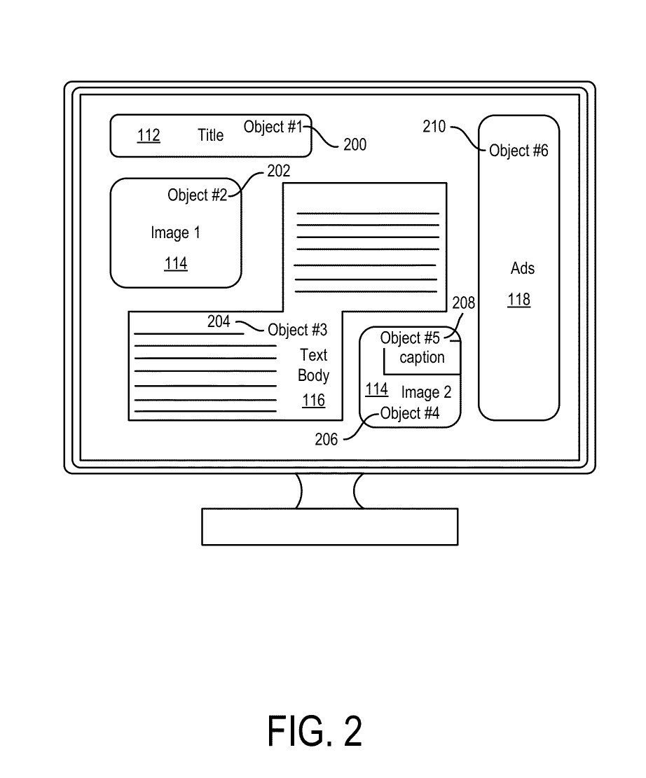

FIG. 2 illustrates the webpage 102 with objects 200 identified in the originator layout 104. Each of the elements on the webpage 102 may be associated with a specific object having an object type. As shown in FIG. 2, the elements on the webpage may be associated with a particular object. The title 112 may be associated with a first object 200. One of the images 114 may be associated with a second object 202. The text body 116 may be associated with a third object 204. The second image 114 may be associated with a fourth object 206. The caption of the image 114 may be associated with a fifth object 208. Finally, the advertisement 118 may be associated with a sixth object 210. Also, the type of object need not be tied to the function of the object. For example, the title 112 may be of any object type e.g. text box, an image, a video, or any other sort of computer-generated object.

By defining elements of the webpage 102 as a collection of objects 200, the objects 200 may be easily moved about, resized, and otherwise manipulated as desired to display the desired web content. In this way, the locations of the objects 200 define the originator layout 104. As the objects 200 are moved, resized, or otherwise manipulated on the originator device 100, the originator layout 104 is also changed. The term object is hereby defined to not only include the abstract idea of an “object,” but also objects, elements, or instances that may be used in computer programs e.g. C, C++, Java, Python, HTML, XML, etc. The objects 200 may also be entries in collection of data, e.g. entries or elements in a database, table, array, or list.

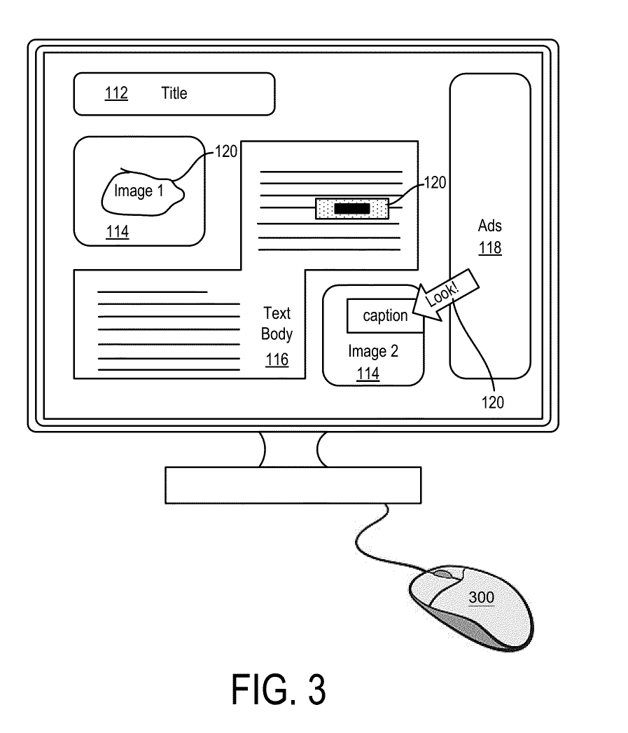

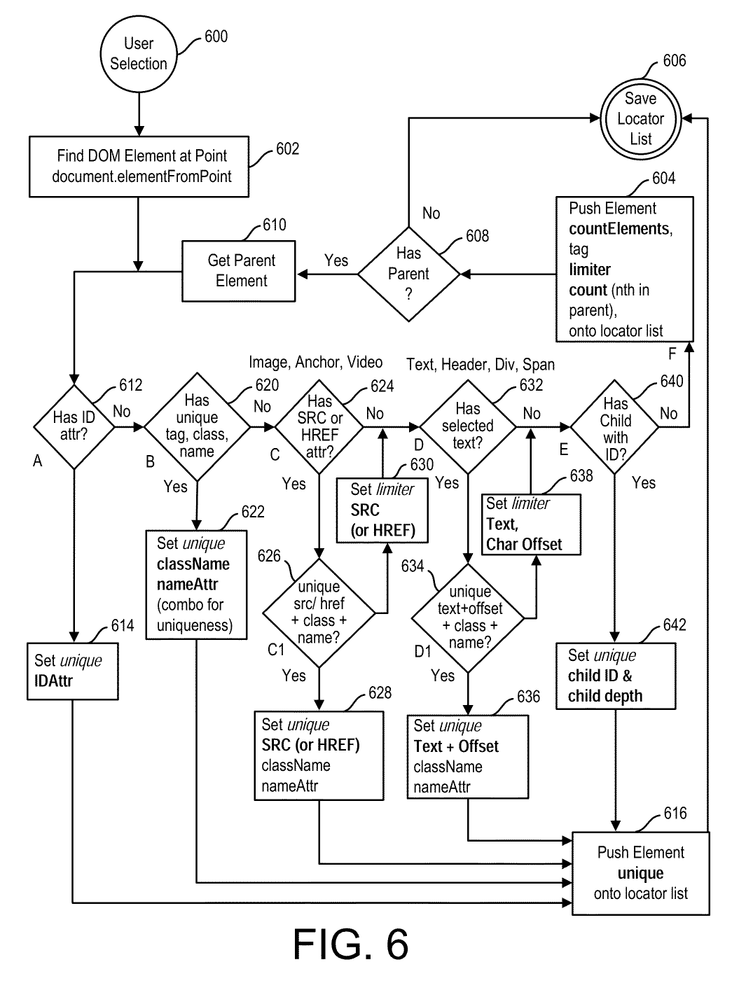

FIG. 3 illustrates mark-up 302 applied to a target object 300 in the originator layout 104. A user may desire to call attention, annotate, or otherwise mark up the webpage 102, usually in reference to one or more of the objects 200 on the webpage 102. In time-varying content, the mark-up 302 may be used to call attention to the object 200 at a particular time, e.g. popping up a window at a certain point of an audio playback, circling a performer being displayed in a video clip at a particular time, etc. An input device 300 may be interpreted by the computer to add, render, represent, or otherwise select the object 200. The input device 300 may be any sort of device capable of receiving user input, e.g. a mouse, trackpad, touchscreen, or stylus. The object desired to be marked up is defined to be the target object 300 and may be selected from the objects 200 present in the webpage 102. The target object 300 may be isolated from the other objects 200 by either the AIS or another computer program. The target object 300 may have one or more attributes that describe the type, location, or other identifying information about the target object 300, e.g. tags, identifiers, query handlers, metadata, or UID's. The AIS uses the attributes available for each of the objects 200 to, when possible, uniquely identify the target object 300 being marked up. The AIS, and attributes of the target object 300 used by the AIS, are presented in greater detail in the discussion of FIG. 6. As shown in FIG. 3, there may be multiple mark-ups 302 applied to the target object 300 in the originator layout 104, or even multiple mark-ups 302 applied to the same target object 300, or any combination or number of mark-ups 302 desired by the user. Any type of the mark-up 302 may be used, e.g. a freehand circle, highlighting of text, an arrow callout, an embedded sound or video file, an image 114, or any kind of user-selected item applied to the target object 300.

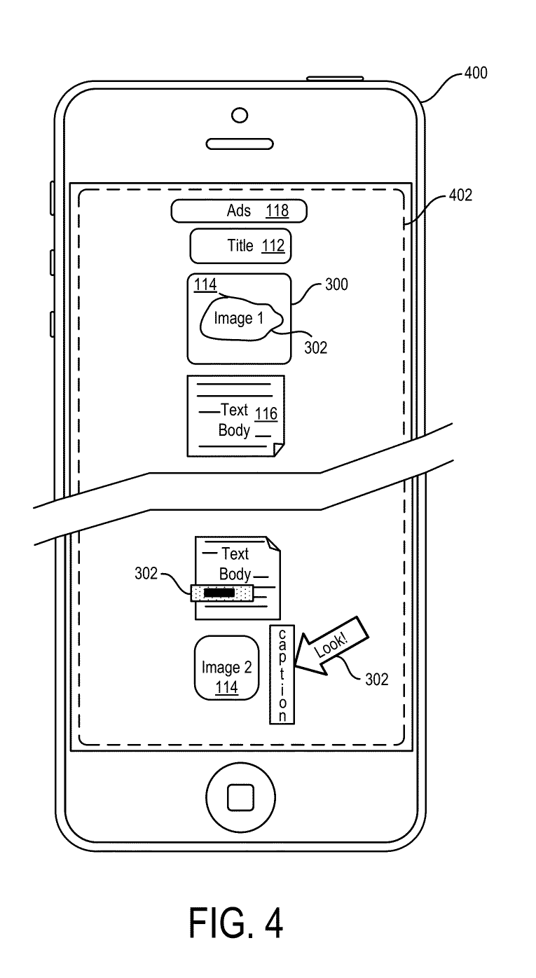

FIG. 4 illustrates a recipient layout 402 of a recipient device 400 displaying the mark-up 302 associated with the target object 300 from the webpage 102. Information about the marked-up target object 300 may be transmitted to a recipient device 400, e.g. a smartphone as shown in FIG. 4. On the smartphone, the webpage 102 has a recipient layout 402, which may be different than the originator layout 104 shown in FIGS. 1-3. The recipient layout 402, in many respects, is similar to that of the originator layout 104 previously described. The recipient layout 402 may have some or all of the objects 200 displayed on the originator device 100. However, because the originator layout 104 and the recipient layout 402 may be different, the mark-up 302 may not be in the same location relative to the originator layout 104 when viewed on the recipient device 400.

The mark-up 302 used to mark up the target object 300 on the webpage 102 displayed on the originator device 100 may be replicated on the webpage 102 as displayed on the recipient device 400. The identifying information on the target object 300 transmitted from the originator device 100 to the recipient device 400 allows the AIS to replicate the mark-up 302 at the correct location on the recipient device 400. As a result, the mark-up 302 conveys the information to the recipient that the originator intended. The mark-up 302 may also be displayed, on the recipient device 400, at the same location, e.g. upper corner of a text box, left hand side of an advertisement, etc. in addition to referencing the same target object 300 as selected by the originator.

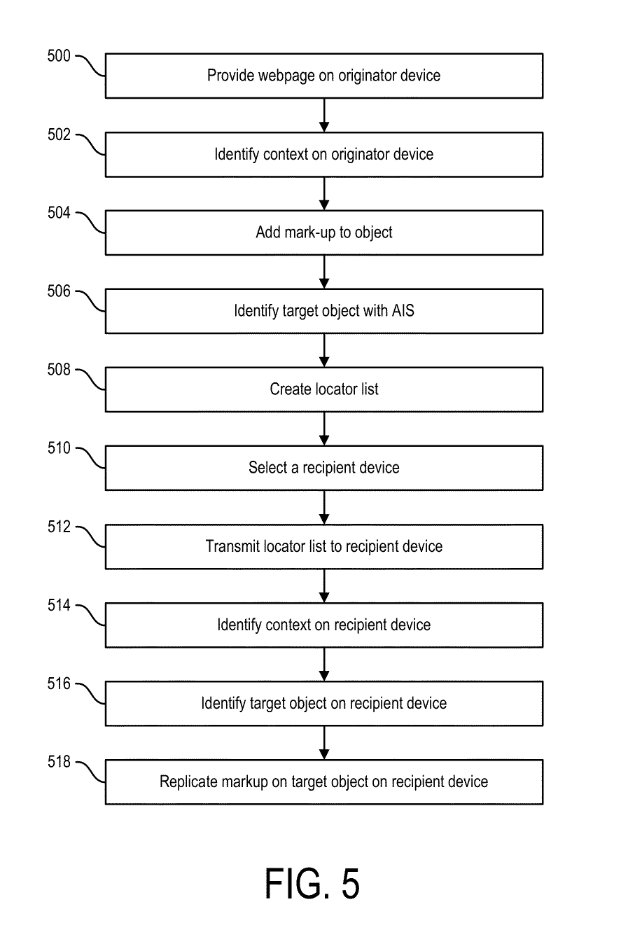

FIG. 5 is a process flow diagram illustrating the steps in generating the mark-up 302 on the target object 300 displayed on the originator device 100 and replicating the mark-up 302 on the recipient device 400.

In block 500 the system generates the webpage 102 on the originator device 100, with the webpage 102 having at least one object 200. The webpage 102 has the originator layout 104 when displayed on the originator device 100. Generation of the webpage 102 may be done by any means, e.g. downloaded from a server, generated by the originator device 100, or generated by a user.

At block 502 the context on the originator device 100 is identified. The context may be any information about the originator device 100 and the webpage 102, e.g. type of device (PC, smartphone, tablet, etc.), the type of web browser being used to display the webpage 102, the URL of the webpage 102, etc. The context may also have information about objects in the webpage 10, e.g. attributes (ID, tag, class, SRC, HREF, text strings, character offsets). The context also includes the originator layout 104, which may include any information about what is displayed on the originator device 100, e.g. the webpage 102, images 114, or videos. The originator layout 104 may also include information about the location of the objects 200 displayed on the originator device 100, e.g. coordinates, depth, metadata, or other reference information.

At block 504 the mark-up 302 is added to the object 200 and displayed on the originator device 100. The object 200 receiving the mark-up 302 is then defined to be the target object 300.

At block 506 the AIS uses the context to identify the target object 300 from the objects 200 present on the webpage 102 displayed on the originator device 100. Examples of the methods by which the AIS may identify the target object 300 from the objects 200 are presented in the discussion of FIG. 6.

At block 508 a locator list is created that references the target object 300. The references may include any identifying information found by the AIS about the target object 300. The locator list may be any sort of list or computer generated structure capable of storing information to identify the target object 300, e.g. a database, array, linked list, object, text file, or spreadsheet.

At block 510 the originator may select a recipient device 400 from a list, e.g. a database, social network, or other group of contacts. The recipient device 400 is the device or devices that will be receiving the locator list. There may be multiple recipient devices 400 and there may be multiple lists used to determine all recipients. For example, the devices of all of the originator's email contacts and phone contacts may be used to form a list of recipient devices 400.

At block 512 the locator list may be transmitted to the recipient device 400. Transmission of the locator list may occur by any means known to one skilled in the art, e.g. wireless, LAN, WLAN, or distributed network. The transmission of the locator list may go through any number of computers, servers, or relays before reaching the recipient device 400. The transmission of the locator list may also be directly from the originator device 100 to the recipient device 400.

At block 514 the context on the recipient device 400 may then be identified in a manner similar to determining the context on the originator device 100 as described in block 502.

At block 516 the target object 300 in the webpage 102 on the recipient device 400 may be identified. This may also be done in a manner similar to determining the target object 300 in the webpage 102 on the originator device 100 as described in block 506.

At block 518 the same mark-up 302 that was made on the originator device 100, in block 504, may be replicated on the target object 300 on the recipient device 400 within the context of the recipient layout 402. The replicated mark-up 302 is then displayed to the recipient in the same manner in which the target object 300 was marked up by the originator, even if the presentation of the webpage 102 is different between the originator device 100 and the recipient device 400.

FIG. 6 is process flow diagram illustrating the AIS determining unique identifiers for the target object 300. In one implementation, the AIS is a computer program or a computer program module that may be executed on any machine capable of executing machine-readable instructions, e.g. computer, mobile device, smartphone, tablet, kiosk, server, or mainframe computer. The AIS determines, to the extent possible, a list of unique or limiting identifiers for the target object 300. The more unique or limiting the identifiers associated with the target object 300 are, the more accurately the target object 300 will be able to be identified on the recipient device 400. The webpage 102 may also be more abstractly be referred to a Document Object Model (DOM) to express the layout of the webpage 102 as a hierarchy of related objects. While FIG. 6 refers to elements, the term “element” and “object” are used interchangeably to represent what is known, to one skilled in the art of object-oriented programming, as an object. Furthermore, when referring to “parent” and “child,” this may be defined to include reference to any hierarchical data e.g. trees, arrays, or networks. They may also refer to an inheritance relationship, e.g. a child object inheriting the functions of the parent object that may be included in any instances of the child object.

The process loop illustrated in FIG. 6 begins at block 600 with a user (originator) selecting content displayed on the originator device 100, which may be the webpage 102 having at the least one object 200. The manner of selecting the content may be any method or means of isolating content from the at least one object 200, e.g. clicking, highlighting, circling, cropping, or applying a call-out. At block 602, the system selects a target object 300 from the at least one object 200 on the webpage 102. At block 604, the system creates a countElements object having a tag attribute and the countElements object is pushed onto a locator list. The countElements object is a counting object that contains information among, at least, the tag attribute and a count which describes the location of the target object 300 in the hierarchy of the at least one object 200. At block 606, the system saves the locator list based upon the countElements object not having a parent element.

In some implementations, in block 608 the system determines (or executes a query) whether the target object 300 has a parent element. The target object 300 may, in some cases, be able to be identified based upon the relationships between the target object 300 and any identified parent objects or child objects. For example, even with the lack of all other identifying information, if the target object 300 has three parent objects and two child objects, and the same relationship, with another object, is uniquely found on the recipient device 400, then it may be stated with a high degree of certainty that the two objects correspond to each other. In block 610 the system gets the parent element based upon the target object 300 having the parent element. The steps described in blocks 604 and 608 are repeated based upon the target object 300 having the parent element. Additional steps, such as the ones described below, may be added between blocks 610 and 604. These steps also repeat in the appropriate sequence following the execution of block 610.

In some implementations, the system determines (or executes queries) which, if satisfied, determine unique identifiers that may be used to locate the target object 300 in the webpage 102 as displayed on the recipient device 400. The implementations described herein may be combined in any way to provide unique identifying information. For example, an identifier such as a text string “Hello Bob” may be found on the webpage 102 displayed on the originator device 100, and may be unique on the originator device 100. There may also be a second identifier found associated with that text string such as an UID for the text box in which the text string is located. When locating the target object 300 in the webpage 102 as displayed on the recipient device 400, there may be two instances of the string “Hello Bob”, but only one of them present in a text box which has the same UID as that found on the originator device 100. This example illustrates the importance of having multiple determinations of identifying information for defining the target object 300 uniquely. Additional implementations, which utilize alternate determinations similar to the above example, are described below.

In some implementations, in block 612 the system determines (or executes a query) if the target object 300 has an ID attribute. In block 614 the system creates a unique object, and sets an ID attribute in the unique object based on the existence of the target object 300 having an ID attribute. In block 616, the system pushes the unique object onto the locator list. Again, in block 606, the system saves the locator list.

In some implementations, at block 620 the system determines (or executes a query) if the target object 300 has a tag attribute, a name attribute, and/or a class attribute. In block 622 the system sets a tag attribute, a name attribute, and a class attribute, in the unique object, based upon the target object 300 having the tag attribute, the name attribute, and the class attribute or any combination thereof. The combination of the three attributes may allow the target object 300 to be uniquely identified. In block 616 the system pushes the unique object onto the locator list. Again, in block 606, the system saves the locator list.

In some implementations, in block 624 the system determines (or executes a query) if the target object 300 has a SRC attribute and/or an HREF attribute. In block 626 the system queries (or executes a query) if the target object 300 has a unique SRC attribute and/or a unique HREF attribute. In block 628 the system sets an SRC attribute and/or an HREF attribute in the unique object based upon the target object 300 having a unique SRC attribute and/or HREF attribute. Block 616 pushes the unique object onto the locator list. Again, in block 606, the system saves the locator list.

In some implementations, in block 630 the system sets a limiter attribute in the countElements object to be the SRC attribute and/or the HREF attribute of the target object 300 based upon the target object 300 having the SRC attribute and/or the HREF attribute, wherein the SRC attribute and/or the HREF attribute is not unique.

In some implementations, in block 632 the system determines (or executes a query) if the target object 300 has a text attribute. In block 634 the system determines (or executes a query) if the target object 300 has a unique text attribute and/or a unique offset attribute. In block 636, the system sets a text attribute and/or an offset attribute in the unique object based upon the existence of the target object 300 having a unique text attribute and/or unique offset attribute. In block 616 the system pushes the unique object onto the locator list. Again, in block 606, the system saves the locator list.

In some implementations, in block 638 the system sets a limiter attribute in the countElements object to be the text attribute and/or the offset attribute of the target object 300 based upon target object 300 having the text attribute and/or the offset attribute, wherein the text attribute and/or the offset attribute is not unique.

In some implementations, in block 640 the system determines (or executes a query) if the target object 300 has a child object with a child ID. Block 642 sets a child ID attribute and a child depth attribute in the unique object based on the target object 300 having a child object, wherein the child object has a child ID. In block 616 the system pushes the unique object onto the locator list. Again, in block 606, the system saves the locator list.

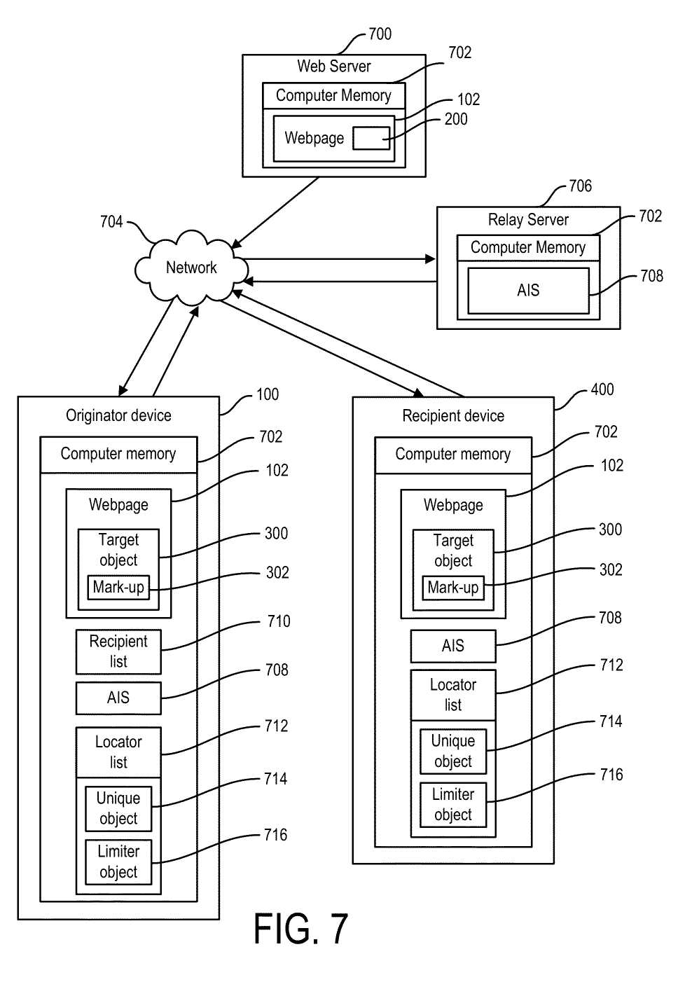

FIG. 7 is a diagram illustrating aspects of a system showing features consistent with implementations of the current subject matter. The above described methods may be executed on system of linked components. In some implementations, there may be a web server 700 connected to a network 704, the web server 700 having the webpage 102 stored in a computer memory 702 of the web server 700, wherein the webpage 102 has the at least one object 200.

There may be the originator device 100, connected to the network 704, the originator device 100 having the webpage 102 stored in a computer memory 702 of the originator device 100, wherein the webpage 102 has a target object 300 and a mark-up 302. The recipient list 710, Anchor Identification Strategy (AIS) 708, and locator list 712 may also be stored in the computer memory 702 of the originator device 100. As discussed above, the locator list 712 may contain the unique object 714 and the limiter object 716.

There may be the recipient device 400, connected to the network 704, the recipient device 400 having the webpage 102 stored in a computer memory 702 of the recipient device 400, wherein the webpage 102 has the target object 300 and the markup 302. A copy or instance of the Anchor Identification Strategy (AIS) 708, and the locator list 712 may also be stored in the computer memory 702 of the recipient device 400. As discussed above, the locator list 712 may contain the unique object 714 and the limiter object 716.

There may be a relay server 706, connected to the network 704, the relay server 706 having an Anchor Identification Strategy (AIS) 708 stored in a computer memory 702 of the relay server 706.

While the subject matter herein refers mostly to webpages and web content, this is not limited to only webpages or web content. Any kind of content capable of being presented on a computer may be used, for example images, video clips, sound clips.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method of identifying, marking-up and reconstituting web content elements for content sharing, the method comprising:
receiving, by an originator device, having a computer memory, from a web server via a network, a webpage, the webpage comprising web content that includes one or more content objects and an originator layout when displayed on a display associated with the originator device;
generating, by a program code module executed on the originator device, a context of the webpage that corresponds to the originator layout;
identifying, by the program code module, at least one of the one or more content objects of the webpage as being a target object selected by a user from the one or more content objects, wherein an identity of the target object is stored on a locator list;
applying, by the program code module and based on the identifying, a mark-up to the target object;
instructing, by the program code module, the server to transmit the mark-up and the locator list to one or more recipient devices;
identifying, by the program code module accessing the locator list, from at least one of the one or more content objects of the webpage present on the recipient device, the target object on the recipient device that corresponds to the target object on the originator device;
applying, by the program code module and based on the identifying, a mark-up to the target object on the recipient device, the mark-up defining a reconstitution of the webpage on the recipient device; and
displaying, by the recipient device, the mark-up on the webpage as viewed on the recipient device.

2. The method in accordance with claim 1, wherein the recipient device is selected, by the program code module, from a recipient list stored in the computer memory of the originator device.

3. The method in accordance with claim 1, wherein the program code module creates a locator list storing attributes associated with the identity of the target object on the originator device, and wherein the locator list is stored in the computer memory of the originator device.

4. The method in accordance with claim 1, wherein the program code module creates a unique object having stored, in machine-readable instructions, attributes associated with the identity of the target object on the originator device, for identifying the target object on the originator device.

5. The method in accordance with claim 4, wherein the program code module creates a limiter object having stored, in machine-readable instructions, attributes associated with the identity of the target object on the originator device, for identifying the target object on the originator device.

6. The method in accordance with claim 5, wherein the unique object and the limiter object are stored in the locator list.

7. A non-transitory machine-readable medium storing instructions that, when executed by a machine, cause the machine to perform operations comprising:
receiving, by an originator device, having a computer memory, from a web server via a network, a webpage, the webpage comprising web content that includes one or more content objects and an originator layout when displayed on a display associated with the originator device;
generating, by a program code module executed on the originator device, a context of the webpage that corresponds to the originator layout;
identifying, by the program code module, at least one of the one or more content objects of the webpage as being a target object selected by a user from the one or more content objects, wherein an identity of the target object is stored on a locator list;
applying, by the program code module and based on the identifying, a mark-up to the target object;
instructing, by the program code module, the server to transmit the mark-up and the locator list to one or more recipient devices;
identifying, by the program code module accessing the locator list, from at least one of the one or more content objects of the webpage present on the recipient device, the target object on the recipient device that corresponds to the target object on the originator device;
applying, by the program code module and based on the identifying, a mark-up to the target object on the recipient device, the mark-up defining a reconstitution of the webpage on the recipient device; and
displaying, by the recipient device, the mark-up on the webpage as viewed on the recipient device.

8. The method in accordance with claim 7, wherein the recipient device is selected, by the program code module, from a recipient list stored in the computer memory of the originator device.

9. The method in accordance with claim 7, wherein the program code module creates a locator list storing attributes associated with the identity of the target object on the originator device, wherein the locator list is stored in the computer memory of the originator device.

10. The method in accordance with claim 7, wherein the program code module creates a unique object having stored, in machine-readable instructions, attributes associated with the identity of the target object on the originator device, for uniquely identifying the target object on the originator device.

11. The method in accordance with claim 10, wherein the program code module creates a limiter object having stored, in machine-readable instructions, attributes associated with the identity of the target object on the originator device, for aiding in identifying the target object on the originator device.

12. The method in accordance with claim 11, wherein the unique object and the limiter object are stored in the locator list.

13. A system comprising:
at least one memory;
at least one processor coupled to the at least one memory and configured to execute instructions stored on the at least one memory that cause the at least one processor to perform operations comprising:
receiving, by an originator device, having a computer memory, from a web server via a network, a webpage, the webpage comprising web content that includes one or more content objects and an originator layout when displayed on a display associated with the originator device;
generating, by a program code module executed on the originator device, a context of the webpage that corresponds to the originator layout;
identifying, by the program code module, at least one of the one or more content objects of the webpage as being a target object selected by a user from the one or more content objects, wherein an identity of the target object is stored on a locator list;
applying, by the program code module and based on the identifying, a mark-up to the target object;
instructing, by the program code module, the server to transmit the mark-up and the locator list to one or more recipient devices;
identifying, by the program code module accessing the locator list, from at least one of the one or more content objects of the webpage present on the recipient device, the target object on the recipient device that corresponds to the target object on the originator device;
applying, by the program code module and based on the identifying, a mark-up to the target object on the recipient device, the mark-up defining a reconstitution of the webpage on the recipient device; and
displaying, by the recipient device, the mark-up on the webpage as viewed on the recipient device.

14. The method in accordance with claim 13, wherein the recipient device is selected, by the program code module, from a recipient list stored in the computer memory of the originator device.

15. The method in accordance with claim 13, wherein the program code module creates a locator list storing attributes associated with the identity of the target object on the originator device, wherein the locator list is stored in the computer memory of the originator device.

16. The method in accordance with claim 13, wherein the program code module creates a unique object having stored, in machine-readable instructions, attributes associated with the identity of the target object on the originator device, for uniquely identifying the target object on the originator device.

17. The method in accordance with claim 16, wherein the program code module creates a limiter object having stored, in machine-readable instructions, attributes associated with the identity of the target object on the originator device, for aiding in identifying the target object on the originator device.

18. The method in accordance with claim 17, wherein the unique object and the limiter object are stored in the locator list.
